(19) United States
(12) Patent Application Publication
(10) Pub. No.: US 2009/0301577 A1
(43) Pub. Date: Dec. 10, 2009

(54) Combination Venturi Check Valve

(76) Inventors: James Anthony Carter, III, East Greenwich, RI (US); Peter Auld Mackay, Warwick, RI (US)

Correspondence Address: MCCARTER & ENGLISH, LLP NEWARK, FOUR GATEWAY CENTER, 100 MULBERRY STREET, NEWARK, NJ, 07102, US

(21) Appl. No.: 12/435,659

(22) Filed: May 5, 2009

Related U.S. Application Data
(60) Provisional application No. 61/126,643, filed on May 6, 2008.

(51) Int. Cl. F16K 17/34

(52) U.S. Cl. 137/484.2

(57) ABSTRACT

Disclosed herein is a combination venturi check valve for introducing a composition, such as ozone, into the fluid circulation line of a swimming pool, spa, and/or other recreational body of water. The combination venturi check valve preferably includes a fluid inlet, a fluid outlet, a venturi passage for suctioning in the composition, and a bypass passage with a valve enabling compatibility with pumps having different flow rates, for example. In an aspect of the invention, the venturi and bypass passages are inline with the fluid inlet and fluid outlet. In another aspect of the invention, the venturi and bypass passages share a common wall, and/or the housing is modular and/or integrally formed. In yet another aspect of the invention, the valve automatically adjusts the flow rate of fluid through the bypass passage without requiring human intervention.

### CROSS-REFERENCE TO RELATED APPLICATIONS

The present application claims the benefit of priority to U.S. Provisional Patent Application No. 61/126,643, filed May 6, 2008.

### FIELD OF THE INVENTION

The present invention relates to a venturi valve for suctioning a composition, such as ozone, into the fluid circulation system of a swimming pool, spa, or other recreational body of water. More specifically, the present invention relates to a valve for a fluid circulation system that includes any one of a plurality of different pumps having disparate pumping rates.

### BACKGROUND OF THE INVENTION

A venturi is an apparatus commonly used to draw a substance, e.g., a composition, into a fluid by use of a pressure difference. Referring to the prior art “full-flow set-up” of FIG. 1, a venturi can be directly contained within a principal flow path. A disadvantage to the full-flow set-up of FIG. 1, for example, is that the pressure drop created across the venturi to form a suctioning vacuum also undesirably acts as a backpressure across the fluid circulation system. Referring to the prior art “bypass set-up” of FIG. 2, an effort has been made in the prior art to inhibit such backpressure by configuring the venturi with a bypass loop. In the bypass set-up of FIG. 2, for example, some circulating fluid is allowed to bypass the venturi, while some circulating fluid still flows to the venturi for suctioning of the composition into the circulating fluid. A drawback to the bypass set-up of FIG. 2 is that, should the flow rate of the fluid circulating across the venturi decrease, then the suction rate of the venturi will decrease, which can lead to an undesirably low amount of suction, thereby reducing the total amount of composition suctioned into the fluid. What is needed in the art is an improved venturi set-up configured to adapt to changes in flow rate.

### SUMMARY OF THE INVENTION

Preferred embodiments of the invention overcome the disadvantages and shortcomings of the prior art by providing a combination venturi check valve. The preferred combination venturi check valve includes a fluid inlet, a fluid outlet, a bypass passage, and a venturi passage. The bypass passage is preferably provided with a check valve movable between a plurality of positions for automatically adjusting the flow rate of fluid through the bypass passage. The venturi passage can be provided with a suction inlet for suctioning a composition into a fluid flowing through the venturi passage.

In some aspects of the invention, the bypass and venturi passages may be inline between the fluid inlet and the fluid outlet, and, in some aspects of the invention, the bypass and venturi passages may share a common wall. In some aspects of the invention, the venturi passage may include a venturi passage inlet side parallel with the bypass passage, and, in some aspects of the invention, the venturi passage may include a venturi passage outlet side having an opening angled with respect to the bypass passage. In some aspects of the invention, the combination venturi check valve defines a mixing chamber positioned between the fluid outlet and the venturi and bypass passages.

Additional features, functions and benefits of the disclosed combination venturi check valve will be apparent from the detailed description which follows, particularly when read in conjunction with the accompanying figures.

### BRIEF DESCRIPTION OF THE DRAWINGS

For a more complete understanding of the present invention, reference is made to the following detailed description of exemplary embodiments considered in conjunction with the accompanying drawings, in which:

FIG. 1 is a schematic view of a prior art full-flow set-up including a venturi;

FIG. 2 is a schematic view of a prior art bypass set-up including a venturi;

FIG. 3 is an exploded front perspective view of a combination venturi check valve constructed in accordance with an exemplary embodiment of the invention;

FIG. 4 is an exploded rear perspective view of the combination venturi check valve of FIG. 3;

FIG. 5 is a left side elevational view of the combination venturi check valve of FIGS. 3 and 4 with a fluid outlet thereof being shown;

FIG. 6 is a right side elevational view of the combination venturi check valve of FIGS. 3-5 with a fluid inlet thereof being shown;

FIGS. 7A and 7B are sectional views of the combination venturi check valve of FIGS. 3-6 taken respectively along section lines 7A-7A and 7B-7B of FIG. 6, a check valve of the combination venturi check valve being shown in a closed state/position; and

FIGS. 8A and 8B are sectional views showing the check valve of FIGS. 7A and 7B in an open state/position.

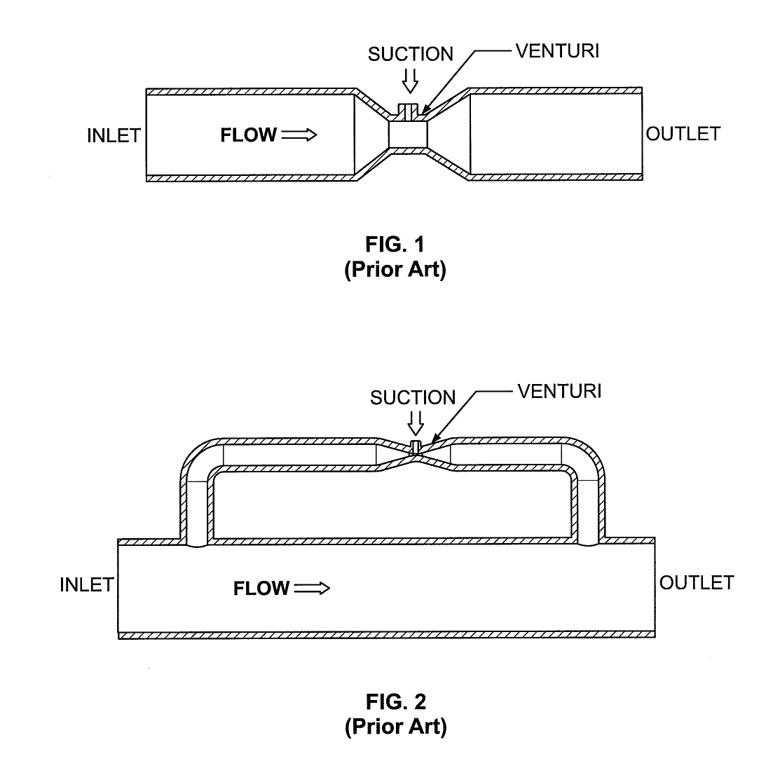

### DETAILED DESCRIPTION OF THE INVENTION

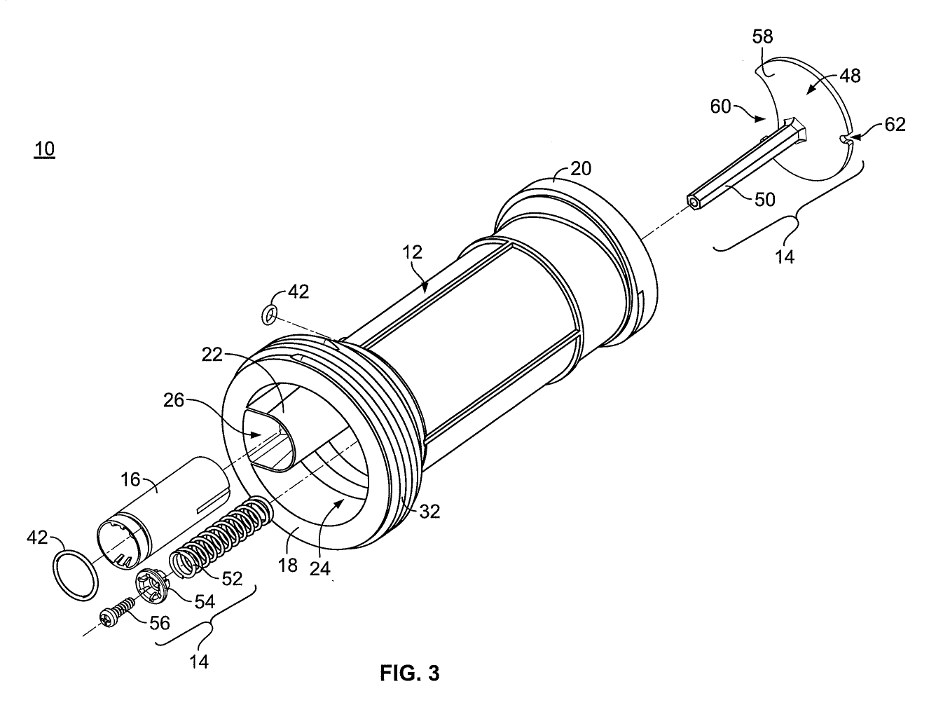

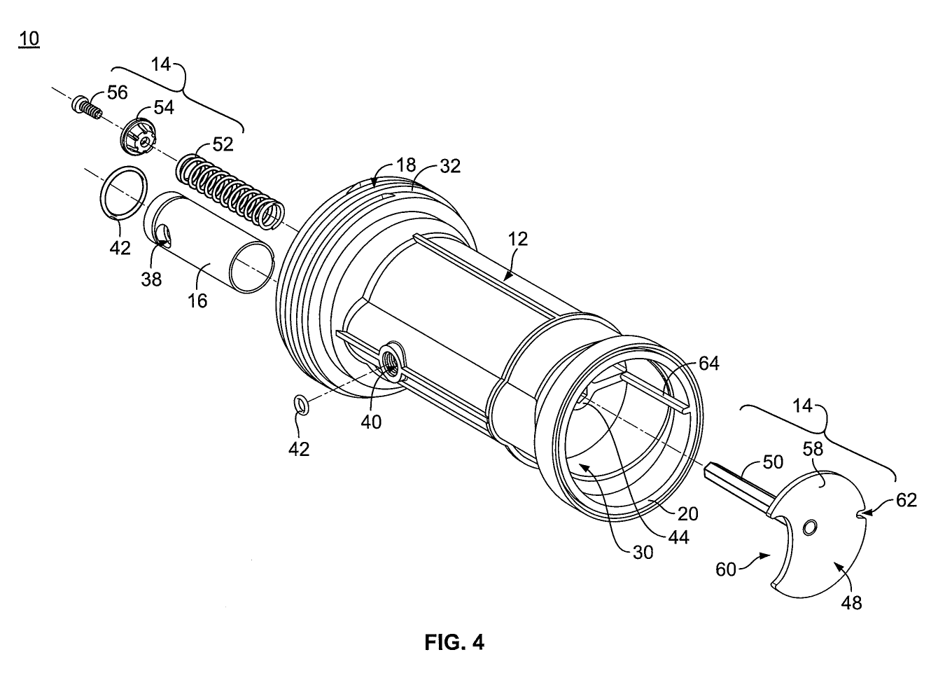

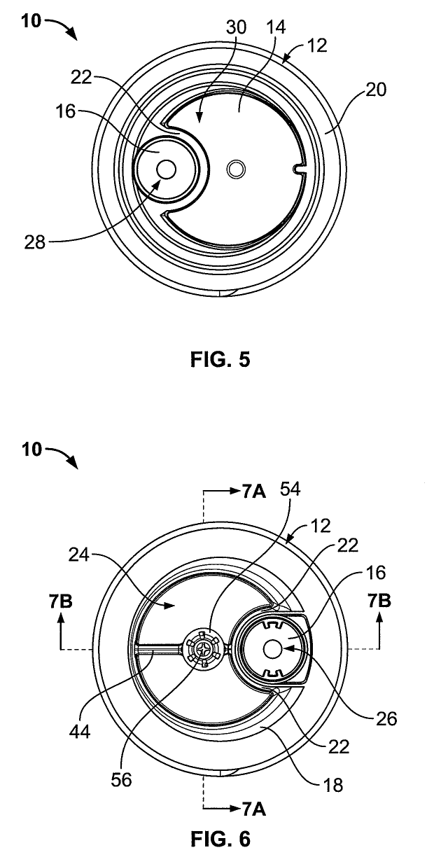

Referring to FIGS. 3-8B, a combination venturi check valve 10 is shown in accordance with an exemplary embodiment of the invention. The combination venturi check valve 10 includes a housing 12, a valve assembly 14, and a venturi device 16, each of which shall be discussed below with further detail.

In the embodiment of FIGS. 3-8B, the combination venturi check valve 10 includes a generally cylindrical pipe housing 12 having a fluid inlet 18, a fluid outlet 20, and a common wall 22 extending therebetween to define a bypass passage 24 and a venturi passage, the latter of which comprises two areas that are referenced herein as a venturi passage inlet side 26 and a venturi passage outlet side 28. The venturi passage inlet side 26 is preferably substantially parallel with respect to the bypass passage 24. A chamber referenced herein as mixing chamber 30 is preferably positioned between the fluid outlet 20 and the passages. Fluid preferably flows from at least one of the passages to the mixing chamber 30 tangentially to enhance mixing and homogeneity.

The housing 12 is preferably monolithically formed from plastic or metal, though it is contemplated that the housing 12 can comprise a plurality of assembled components, such as an inlet half or portion and an outlet half or portion, for example. The housing 12 can be provided with means for securing the housing 12 in fluid communication with the fluid circulation system. As shown in FIGS. 3-8B, for example, such means can include, at the fluid inlet 18, threading 32 to be secured with corresponding threading of the fluid circulation system, and, at the fluid outlet 20, an annular groove 34 for receiving a corresponding annular lip of the fluid circulation system. Seals can be provided for efficient communication of fluids.

In some embodiments, the bypass passage 24 and venturi passage are provided inline with the fluid inlet 18 and the fluid outlet 20. For example, as shown in FIGS. 3-8B, fluid flowing into the fluid inlet 18 flows substantially straight into both the bypass passage 24 and the venturi passage inlet side 26, and fluid flows substantially straight out of the mixing chamber 30 through the fluid outlet 20. The inline configuration inhibits turbulence, enhances laminar flow, and contributes to overall efficiencies.

In some embodiments of the invention, the common wall 22 can be provided to subdivide the interior of the pipe housing 12 into the bypass passage 24 and the venturi passage, and, in some embodiments, the common wall 22, which can be formed integrally as part of the housing 12, contributes to the compactness and portability of the combination venturi check valve 10. The venturi passage outlet side 28 preferably includes an angled opening 36 for inducing tangential flow from the venturi passage outlet side 28 to the mixing chamber 30.

The venturi passage is provided with means for suctioning a composition into fluid flowing through the venturi passage. For example, the venturi device 16 can be positioned within the venturi passage. In the example of FIGS. 3-8B, the venturi device 16 is positioned within the venturi passage inlet side 26. Water flows through the venturi passage inlet side 26 to the venturi device 16 and therefrom through the venturi passage outlet side 28. The venturi device 16 comprises a constricted section and a suction inlet 38 proximal the constricted section for suctioning a composition, such as ozone, through the suction inlet 38 from a composition reservoir, such as an ozone dispensing unit, into the fluid flow. The suction inlet 38 is aligned with and in fluid communication with a hole 40 formed in the housing 12, which is in further fluid communication with the composition reservoir. The hole 40 can be threaded to securingly receive a secondary check valve (not shown) positioned between the composition reservoir and the suction inlet 38 and allowing one-way fluid communications from the composition reservoir to the suction inlet 38.

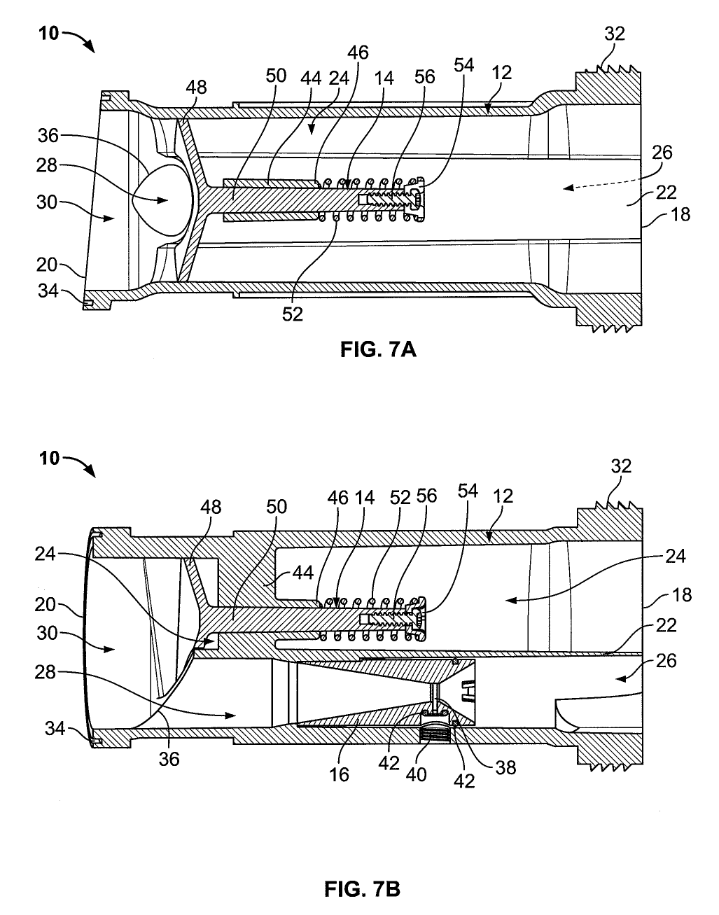

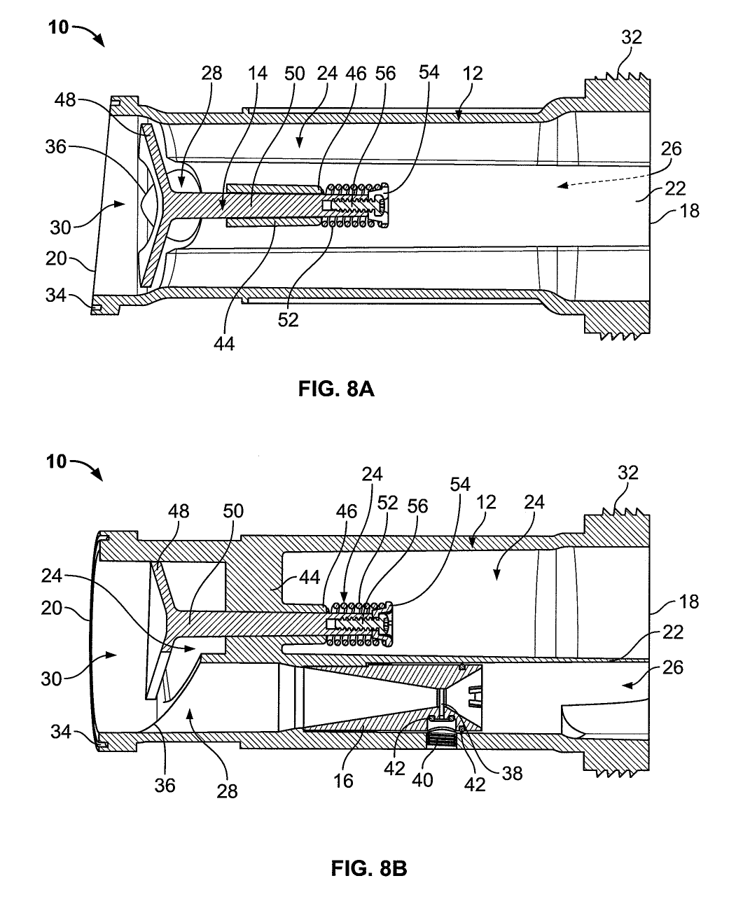

As shown in FIGS. 7B and 8B, to retain the venturi device 16 within the housing 12, an interference fit can be formed by the cooperation of a step formed in the common wall 22 and a seat (not designated) formed in the venturi device 16. To further secure and seal the interference fit, a plurality of O-rings 42 can be provided. It is contemplated that alternative and/or additional means can be provided with respect to the venturi device 16. For example, it is contemplated that those inner surfaces defining the venturi passage can themselves form the constricted section for inducing the venturi effect.

In some aspects, the housing 12 and the means for suctioning can be formed of different materials. For example, while the housing 12 is preferably formed of a plastic or metal, it is contemplated that the venturi device 16, for example, can be formed of a material resistant to that composition that would be sucked therethrough. For example, in the case of ozone, the venturi device 16 can be formed of a material resistant to the corrosive properties of ozone, such as those materials manufactured by Kynar, e.g., polyvinylidene fluoride (PVDF). It is contemplated that the secondary check valve (not shown) positionable between the suction inlet 38 and composition reservoir can additionally or alternatively be formed of a Kynar material, e.g., PVDF.

Regarding the bypass passage 24, the combination venturi check valve 10 is provided with a mount 44 for securing the valve assembly 14 relative to the housing 12. In some embodiments, such as that embodiment shown in FIGS. 3-8B, the mount 44 is included as an integral portion of a monolithic housing 12. The mount 44 can extend from the common wall 22 to an opposing wall of the housing 12 that cooperates therewith to define the bypass passage 24. The mount 44 includes an area, referenced herein as a spring seat 46, which has a borehole for securing the housing 12 to the valve assembly 14, while permitting the valve assembly 14 to alter its state between a plurality of positions.

The valve assembly 14 preferably includes a valve head 48, a valve stem 50, a compression spring 52, a spring retainer 54, and a fastener 56, each of which shall be discussed below with further detail. The valve head 48 is preferably sized and dimensioned to, when in a closed position, obstruct fluid flow from the bypass passage 24 to the fluid outlet 20 (and the mixing chamber 30), while allowing fluid flow from the venturi passage outlet side 28 to the fluid outlet 20. The bypass passage 24 and the valve head 48 are configured to form a seal in the closed position. The valve head 48 can include a valve head wall 58 defining an open area 60, and the valve head 48 is aligned with the passages such that the valve head wall 58 can alternatively obstruct and allow fluid flow from the bypass passage 24 to the fluid outlet 16, while the open area 60 continuously allows fluid flow from the venturi passage outlet side 28 to the fluid outlet 20. A keyed hole 62 can be formed in the valve head wall 58, and a complementary rib 64 can be formed in the housing 12 for guiding alignment of the valve head 48 and to facilitate reciprocation that is substantially linear.

The valve stem 50 extends from the valve head 48 and through a bore or opening formed in the spring seat 46 of the mount 44. The radius of the bore in the spring seat 46 is just greater than a radius of the valve stem 50 to guide sliding, linear reciprocation of the valve stem 50, while inhibiting lateral motion thereof. In this regard, the mount 44 can function to guide the valve. The valve stem 50 can be further configured so as to prevent or inhibit rotation of the valve head 48. For example, as shown in the example of FIGS. 3-8B, the valve stem 50 can be shaped as a hexagon, and the borehole formed in the spring seat 46 of the mount 44 can be correspondingly shaped as a hexagon to inhibit rotation.

The valve stem 50 has a threaded hole opposing the spring seat 46 of the mount 44, and the fastener 56 extends through the hole to secure the spring retainer 54 to the valve stem 50. The radius of the valve stem 50 is less than the radius of the spring retainer 54 (and the radius of the valve stem 50 is less than the radius of the spring seat 46). The compression spring 52 is positioned about the valve stem 50 between the spring retainer 54 and the spring seat 46.

In use, the fluid inlet 18 of the combination venturi check valve 10 is secured in fluid communication with an outlet of the fluid circulation system, and the fluid outlet 20 of the combination venturi check valve 10 is secured in fluid communication with an inlet of the fluid circulation system. As fluid flows through the fluid inlet 18, the fluid flow path diverges into the venturi passage inlet side 26 and the bypass passage 24. The valve assembly 14 is movable from a closed position, in which fluid flow from the bypass passage 24 to the fluid outlet 20 (and the mixing chamber 30) is obstructed, to one of a plurality of open positions, such as a partially-open position or a fully-open position, in which varying amounts of fluid flow are allowed to flow from the bypass passage 24 to the fluid outlet 20 (and the mixing chamber 30). The venturi passage outlet side 28 preferably includes the angled opening 36 so as to provide a tangential flow for enhancing mixing and homogeneity, preferably prior to exit of the fluid through the fluid outlet.

The position of the valve assembly 14 is dependent at least in part on the force of the fluid pressure against the valve head wall 58 of the valve head 48, which is in turn at least partially dependent on fluid flow rate, and which is in turn at least partially dependent upon the pumping rate of that pump which has been included as part of the fluid circulation system. Though any number of configurations are contemplated, it is preferred that the compression spring 52 have a spring rate between about forty pounds per inch (40 lbs/in) and about fifty-five pounds per inch (55 lbs/in) for an operational flow rate between about ten gallons per minute (10 GPM) to about one-hundred-and-ten gallons per minute (110 GPM) and a venturi air suction of about six cubic feet per hour (6 SCFH) to about seven cubic feet per hour (7 SCFH).

The valve assembly 14 or other valve/throttle mechanism is preferably contained within the pipe housing 12 and inserted into the mount 44. The valve assembly 14 or other valve/throttle mechanism is capable of moving within the housing 12 between an open and closed position. The movement of the valve assembly 14, for example, is regulated by the compression spring 52 held in place by the spring retainer 54 that is attached to the valve stem 50 of the valve assembly 14. It is contemplated that the spring retainer 54 can be adjustable such that the compression spring 52 can be preloaded with compression to change the opening rate of the valve assembly 14 so as to enable the valve assembly 14 or other valve/throttle mechanism to resist opening due to flow in order to maintain pressure for the venturi. As pressure increases, the valve/throttle mechanism, e.g., the valve assembly 14, will open based on the spring rate of the compression spring 52. In this regard, a wide range of flows and pressures are contemplated, while meeting a desired minimum venturi suction rate, and while reducing the amount of back pressure created at higher flow rates. The flow exiting the bypass passage 24 is preferably directed into the path of the flow from the venturi passage outlet side 28 at a chamber in the housing 12 proximal the fluid outlet 20. By directing the flow from the valve assembly 14, a higher velocity flow is promoted for better mixture between the two passages prior to exiting the fluid outlet 20.

By containing a venturi and a pressure-operated valve within a single unit, for example, many drawbacks of the prior art can be overcome. For example, with respect to the embodiment of FIGS. 3-8B, if the fluid flow from the fluid circulation system drops, the valve assembly 14 can close completely or partially, thereby reducing the amount of flow within the bypass passage 24. This increases the pressure at the venturi suction inlet 38 to provide desired suction rates. If the fluid flow from the fluid circulation system increases, the valve assembly 14 opens (or opens further) to release the excess pressure build up. In this regard, preferred embodiments of the invention are particularly useful for configurations in which variable flow rates are desirable, where the benefits of both a bypass set-up and the benefits of a full flow set-up are sought in one set-up.

Thus, in some aspects of the invention, apparatus and methods are provided for maintaining a relatively constant venturi inlet pressure by use of a pressure sensitive check valve in an “all-in-one” unit. A fluid traveling at a given pressure enters the apparatus, such as the combination venturi check valve 10 of FIGS. 3-8B, and is regulated by a valve/throttle mechanism, such as the valve assembly 14 of FIGS. 3-8B. The valve throttle mechanism is sized such that it preferably maintains the ideal inlet pressures for the venturi. The valve throttle mechanism restricts flow to create optimal venturi pressure. If the optimal amount of pressure is surpassed, the valve mechanism will open a determined amount depending on the increase in pressure (and the spring rate, for example). The amount the valve mechanism opens will determine at least in part the decrease in pressure at the venturi. This reduces the pressure to the optimal amount at any given inlet pipe pressure induced by different pumping rates.

In some aspects, the combination venturi check valve 10 inhibits excess back pressure created through the venturi and the fluid circulation system to maintain a substantially constant suction rate. Flow from the outlet of the bypass area, such as the bypass passage 24 of FIGS. 3-8A, will then be directed with the main flow of the venturi passage outlet side 28 proximal the fluid outlet 20 of the housing 12. Such promotes a higher velocity flow in a chamber (e.g., mixing chamber 30) for optimizing the mixture of the two fluids prior to leaving the housing 12 through the fluid outlet 20. This also reduces the amount of back pressure created at higher flow rates. By directing the flow from the valve assembly 14 or other valve/throttle mechanism toward flow from the venturi passage outlet side 28, a higher velocity flow is promoted for better mixture for the drawn composition between the two passages prior to exiting the fluid outlet 20, for example.

Embodiments of the invention additional to those shown in FIGS. 3-8B are contemplated. For example, it is contemplated that one or more seal(s) can be provided to the outer edge of the combination venturi check valve 10 (or in other positions) to inhibit or prevent fluid or composition leakage. It is contemplated that the present invention can be used in water treatment contexts outside of ozonation of swimming pool water.

With respect to the valve/throttle mechanism, it is contemplated that valve means in addition to or alternative to the valve assembly 14 and/or components thereof can be utilized. For example, the valve means can be provided as a throttle plate capable of rotating as flow increases. The amount of rotation between a closed position and a plurality of open positions can be regulated by a torsion spring that resists the flow of fluid through a bypass passage. Additionally or alternatively, the throttle plate can be provided as an impeller shaped to induce a rotational effect for facilitating mixing.

It is also contemplated that a combination venturi check valve can be provided such that a venturi can be contained within a valve placed at the center of the housing in a parallel path to the bypass area of the housing. The bypass area is regulated by means of the sliding valve that restricts flow up to a given pressure. The movement of this valve between open and closed position is controlled by a compression spring that resists the fluids path. As the valve opens the venturi's suction inlet grows in diameter. An increase in flow would result in an increase in suction.

It will be understood that the embodiments of the present invention described herein are merely exemplary and that a person skilled in the art may make many variations and modifications without departing from the spirit and the scope of the invention. All such variations and modifications, including those discussed above, are intended to be included within the scope of the invention as defined by the appended claims.

What is claimed is:

1. A combination venturi check valve for introducing a composition into a fluid circulation line of a recreational body of water, comprising:
a housing having a fluid inlet, a fluid outlet, a venturi passage, and a bypass passage sharing a common wall with said venturi passage, said venturi and bypass passages configured to have fluid flow therethrough substantially inline with said fluid inlet and said fluid outlet;
means provided with said venturi passage for suctioning a composition into fluid flowing through said venturi passage; and
check valve means provided in said bypass passage for allowing and obstructing fluid flow through said bypass passage to said fluid outlet in accordance with fluid force, said check valve means movable between (i) a closed position, in which fluid flow through said bypass passage is obstructed, and (ii) a plurality of open positions, in which fluid flow through said bypass passage is allowed.

2. The combination venturi check valve of claim 1, wherein said housing includes an opening, and wherein said means for suctioning includes a venturi device having a suction inlet in fluid communication with said opening.

3. The combination venturi check valve of claim 1, including a mount securing said check valve means relative to said bypass passage while allowing said check valve means to move between open and closed positions.

4. The combination venturi check valve of claim 3, wherein said check valve means comprises a check valve assembly including a valve head, a valve stem extending from said valve head through said mount, a spring retainer secured to said valve stem opposite said mount, and a compression spring about said valve stem and between said mount and said spring retainer.

5. The combination venturi check valve of claim 1, wherein said housing defines an interior space thereof, and wherein said common wall is positioned at least partially within said interior space so as to divide said interior space at least into said passages.

6. The combination venturi check valve of claim 1, wherein said venturi passage includes a venturi passage inlet side extending substantially parallel with respect to said bypass passage.

7. The combination venturi check valve of claim 1, wherein said combination venturi check valve is provided with a mixing chamber between said fluid outlet and said passages.

8. The combination venturi check valve of claim 7, wherein at least one of said passages includes an angled opening for tangential fluid flow to said mixing chamber.

9. A combination venturi check valve for introducing a composition into a fluid circulation line of a recreational body of water, comprising:
a housing having a fluid inlet, a fluid outlet, a venturi passage, and a bypass passage, said venturi and bypass passages configured to have fluid flow therethrough substantially inline with said fluid inlet and said fluid outlet;
means provided with said venturi passage for suctioning a composition into fluid flowing through said venturi passage; and
a check valve in said bypass passage and movable between a closed position configured to obstruct fluid flow through said bypass passage, and a plurality of open positions each configured to allow fluid flow through said bypass passage.

10. The combination venturi check valve of claim 9, including a mount securing said check valve relative to said bypass passage while allowing said check valve to move linearly, wherein said check valve includes a valve head, a valve stem extending from said valve head through said mount, a spring retainer secured to said valve stem opposite said mount, and a compression spring about said valve stem and between said mount and said spring retainer.

11. The combination venturi check valve of claim 10, wherein said compression spring has a spring rate between about forty pounds per inch and about fifty-five pounds per inch.

12. The combination venturi check valve of claim 9, wherein said venturi passage includes a venturi passage inlet side extending substantially parallel with respect to said bypass passage.

13. The combination venturi check valve of claim 9, wherein said combination venturi check valve is provided with a mixing chamber between said fluid outlet and said passages.

14. The combination venturi check valve of claim 13, wherein at least one of said passages includes an angled opening for tangential flow to said mixing chamber.

15. The combination venturi check valve of claim 9, wherein said housing is modular, and wherein said check valve is alternatively responsive to a first fluid force associated with a first pumping rate and a second fluid force associated with a second pumping rate unequal to the first pumping rate.

16. The combination venturi check valve of claim 15, wherein the first and second pumping rates are each between about ten gallons per minute and one-hundred-and-ten gallons per minute.

17. A combination venturi check valve for introducing a composition into a fluid circulation line of a recreational body of water, comprising a modular housing having a fluid inlet, a fluid outlet, and an interior space therebetween and at least divided into a bypass passage and a venturi passage, said venturi passage provided with a constricted portion for suctioning a composition into said venturi passage, said venturi passage including a venturi passage inlet side substantially parallel with respect to said bypass passage; and a check valve movable between a closed position and a plurality of open positions in accordance with fluid force so as to substantially maintain pressure level proximal said constricted portion.

18. The combination venturi check valve of claim 17, including a mount securing said check valve relative said bypass passage while allowing said check valve to reciprocate linearly, wherein said check valve includes a valve head, a valve stem extending from said valve head through said mount, a spring retainer secured to said valve stem opposite said mount, and a compression spring about said valve stem and between said mount and said spring retainer.

19. The combination venturi check valve of claim 17, wherein said housing is integrally formed.

20. The combination venturi check valve of claim 17, wherein said combination venturi check valve is provided with a mixing chamber between said fluid outlet and said passages.

21. The combination venturi check valve of claim 20, wherein said venturi passage outlet side includes an angled opening for tangential flow to said mixing chamber.

22. In a fluid circulation system for a swimming pool, the fluid circulation system being configured to interchangeably receive a pump selected from a plurality of pumps having disparate pumping rates, and the fluid circulation system at least including said pump and a composition reservoir, the improvement being valve apparatus comprising:
a modular housing having a fluid inlet in fluid communication with said fluid circulation system, a fluid outlet in fluid communication with said fluid circulation system, said housing having venturi and bypass passages being in parallel path between said fluid inlet and said fluid outlet;
means provided with said venturi passage for suctioning a composition into fluid flowing through said venturi passage; and
a check valve in said bypass passage and automatically movable between a closed position and a plurality of open positions in accordance, at least in part, with a pumping rate of said pump.

23. A combination venturi check valve, comprising a single housing having inlet and outlet sections; a venturi contained within said housing in parallel path to a bypass area of the housing, said bypass area being regulated by a sliding valve within said housing, and a compression spring that resists fluid controlling movement of said sliding valve between open and closed positions.
